(19) United States
(12) Patent Application Publication
(10) Pub. No.: US 2020/0158322 A1
(43) Pub. Date: May 21, 2020

(54) LAMP LIGHT SOURCE ASSEMBLY, ILLUMINATION ASSEMBLY, AND ILLUMINATION LAMP FOR ROAD ILLUMINATION

(71) Applicants: TUNGHSU OPTOELECTRONIC TECHNOLOGY CO., LTD., Shijiazhuang, Hebei (CN); HUZHOU MINGSHUO OPTOELECTRONIC TECHNOLOGY CO., LTD., Zhejiang (CN)

(72) Inventors: Wei CHEN, Huzhou City, Zhejiang (CN); Libin ZHOU, Huzhou City, Zhejiang (CN); Wei JIANG, Huzhou City, Zhejiang (CN)

(21) Appl. No.: 16/612,973

(22) PCT Filed: Dec. 29, 2017
(86) PCT No.: PCT/CN2017/119929

§ 371 Date: Nov. 12, 2019

(30) Foreign Application Priority Data
May 10, 2017 (CN) 201710324906.2

(51) Int. Cl. F21V 29/74; F21V 29/89; F21V 29/85; F21K 9/237; F21S 8/08

(52) U.S. Cl. CPC F21V 29/745; F21V 29/89; F21Y 2115/10; F21K 9/237; F21S 8/086; F21V 29/86

(57) ABSTRACT

A lamp illumination assembly for road illumination includes a driving power supply, a fixing support, a rubber ring, a level gauge, a base, a radiator, a plug, an LED light source and a lens. The radiator is configured as a semicircular column. By means of integrated structural design, the mounting size is reduced. The lamp is equipped with a universal connecting component for a conventional sodium lamp or LED lamp to achieve close connection between the lamp and the structure of a light source assembly. By integrating high-power LED beads to a substrate, providing an integrated lens with specific light distribution, matching the structural design of the radiator, and applying heat conduction, storage and dissipation materials, the lamp overcomes the defects of conventional road lamps and common LED road lamps, and achieves low light degradation, high light efficiency, high energy saving rate, long service life, and quick non-destructive replacement.

### FIELD OF THE INVENTION

The present invention belongs to the field of illumination technology, particularly relates to a novel road illumination lamp.

### BACKGROUND OF THE INVENTION

In recent years, as China's economic development is growing rapidly, currently, on the whole, it has reached the stage of development that promotes agriculture through industry and drives the countryside with the city. The development of production is the central part of the novel rural construction, and the material basis for achieving other goals. Wherein accelerating rural public infrastructure, in particular road construction, is the top priority for accelerating development. In the gradual development today, the quality of life and living environment of rural residents in China have gradually improved, and the cultural life of rural areas has become more and more abundant. The scope of activities brought about by the mentioned above has increased, and the demand for roads and road illumination in rural areas has also increased. Under this background, higher requirements have been placed on the field of road illumination.

Currently, most rural areas still use a conventional high pressure sodium lamp or energy saving lamp, this light source lamps have defects of high power consumption rate, the uneven light distribution, low light utilization rate, large light pollution, short life, and the like.

Now, in some rural areas, in response to national policies and requirements for energy conservation and emission reduction, some conventional road lamps have been replaced with LED road lamps, however, such common LED road lamps generally have lower light efficiency, uneven light distribution, larger light decay, and replacement of LED lamps from conventional lamps has defects of longer replacement time, higher cost, poor matching, low safety factor, and later maintenance inconvenience.

The applicants of the present application have developed a graphene heat-dissipation LED lamp by providing a plurality of light source modules and power supply modules to be assembled into novel type of LED road illumination lamps. By providing the grapheme-containing material, the LED road illumination lamp improves the thermal conductivity of the entire LED, the light efficiency is 200% higher than conventional sodium lamps and 30% higher than conventional LED lamps.

Although this grapheme heat-dissipation LED illumination lamp has a high light efficiency, but the cost of manufacture and installation is high. Most of the current rural roads still uses sodium lamp or common LED lamp, the lamp casings of these lamps are similar in structure. The graphene heat-dissipating LED lamp developed by the applicants of the present invention provides a plurality of light source modules on the light source lining plate by providing different modules, the power supply is provided on the power supply lining, and the light source lining plate and the power supply lining plate are connected and formed an LED module assembly through a waterproof plug. This structural arrangement is significantly different from the conventional sodium lamp or LED lamp overall structure. Therefore, once a large-area road lamp is replaced, the original sodium lamp or LED lamp casing body will be forcibly discarded, resulting in great waste of resources, and take up a lot of manpower.

### SUMMARY OF THE INVENTION

To overcome the above technical problems, the present invention provides a road illumination lamp which is easy to install, economical and has a long service life. By integrated structural design, the mounting volume is reduced, the lamp of the present invention is equipped with universal connecting component for a conventional sodium lamp or an LED lamp to achieve close connection with the structure of a light source assembly inside the conventional road lamp; by integrating a plurality of high-power LED beads to a substrate, providing an integrated lens with specific light distribution, matching the structural design of the radiator, and applying the graphene heat dissipation material, the lamp of the present invention overcomes the defects of conventional road lamps and common LED road lamps, and achieves advantages of low light decay, high light efficiency, high energy saving rate, long service life, quick non-destructive replacement, and the like.

The present invention provides a novel road illumination lamp light source assembly, comprising: a radiator and an LED light source; the radiator is provided in a semicircular column.

Wherein, the light source is attached on the horizontal end face of the radiator through a graphene-containing heat-conducting silicone grease.

Wherein, the semicircular surface of the radiator is shaped into a hollow grille.

Wherein, the radiator may employ an aluminum material, a ceramic material, and/or other metal material having good heat dissipation performance.

Wherein, the semicircular outer surface of the radiator is sprayed with a graphene-containing fluororesin material.

The present invention further provides a novel road illumination lamp illumination assembly, comprising: the light source assembly mentioned above, a driving power supply, a support, a level gauge, a plug, and a lens.

Wherein, the support may be integrally formed, or may be separately formed, the separately formed support comprises a fixed support and a base.

The level gauge in the lamp illumination assembly of the present invention may also be referred to as a level bubble, which is itself marked with the corresponding scale, to check whether the mounting position of the lamp is in a horizontal position.

Wherein, the driving power supply is connected to the radiator through the support.

Wherein, in the case where the support is separately formed, the driving power supply is connected with the base, the base is connected to the fixed support, a rubber ring is provided at a connection position of the fixed support and the base, the fixed support is further connected to the radiator, the LED light source is attached and fixed on the horizontal end face of the radiator through a graphene-containing heat-conducting silicone grease, the lens is fixedly mounted on the horizontal end face of the radiator, the LED light source is disposed between the radiator and the lens.

In the case where the support is integrally formed, the driving power supply is connected to the support, the support is further connected to the radiator, the LED light source is attached and fixed on the horizontal end face of the radiator through a graphene-containing heat-conducting silicone grease, the lens is fixedly mounted on the horizontal end face of the radiator, the LED light source is provided between the radiator and the lens.

Wherein, the LED light source employs COB light source.

The present invention further provides a road illumination lamp, comprising a lamp casing and a illumination assembly, the lamp casing may employ the conventional sodium lamp casing.

The illumination lamp also has a holder and a reflector, the reflector is fixedly mounted in the lamp casing by screws, a circular opening is provided at the tail of the reflector for the illumination assembly to pass through.

### The Beneficial Effect of Technology

The road illumination lamp provided by the present invention reduces the mounting volume by the integrated structural design, the lamp of the present invention is equipped with universal connecting component for a conventional sodium lamp or an LED lamp to achieve close connection with the structure of a light source assembly inside the conventional road lamp; by integrating a plurality of high-power LED beads to a substrate, providing an integrated lens with specific light distribution, matching the structural design of the radiator, and applying heat conduction, heat storage and heat dissipation materials, the lamp of the present invention overcomes the defects of conventional road lamps and common LED road lamps, and achieves advantages of low light decay, high light efficiency, high energy saving rate, long service life, quick non-destructive replacement, and the like.

### BRIEF DESCRIPTION OF THE DRAWINGS

FIG. 1 is an exploded view of the overall structure of the road illumination lamp illumination assembly;

FIG. 2 is a front view of the radiator of the road illumination lamp of the present invention;

FIG. 3 is a side view of the radiator of the road illumination lamp of the present invention;

FIG. 4 is a bottom view of the radiator of the road illumination lamp of the present invention;

FIG. 5 is an exploded view of the overall structure of the road illumination lamp of the present invention;

FIG. 6 is assembly drawing of the road illumination lamp of the present invention.

### DETAIL DESCRIPTION OF THE INVENTION

A novel road illumination lamp illumination assembly provided by the present invention, comprising: a driving power supply, a fixed support, a rubber ring, a level gauge, a base, a radiator, a plug, an LED light source and a lens.

A novel road illumination lamp illumination assembly provided by the present invention, comprising: a driving power supply, a support, a level gauge, a radiator, a plug, an LED light source and a lens.

The driving power supply is connected to the radiator by the support, the radiator is connected to the LED light source, these three parts constitute the main structure of the lamp illumination assembly.

The LED light source and the radiator constitute a light source assembly.

In the present invention, the driving power supply is connected to the base, the base is connected to the fixed support, a rubber ring is provided at a connection position of the fixed support and the base, the fixed support is further connected to the radiator, the LED light source is attached and fixed on the horizontal end face of the radiator through a graphene-containing heat-conducting silicone grease, the lens is fixedly mounted on the horizontal end face of the radiator, the LED light source is provided between the radiator and the lens.

In another embodiment, the driving power supply is connected to the support, the support is further connected to the radiator, the LED light source is attached and fixed on the horizontal end face of the radiator through a graphene-containing heat-conducting silicone grease, the lens is fixedly mounted on the horizontal end face of the radiator, the LED light source is provided between the radiator and the lens.

In a specific embodiment, the driving power supply is connectedly fixed to the base by screws, the base is connected to the fixed support, a rubber ring is provided at a connection position of the fixed support and the base for two sealed connections, the fixed support is further connected to the radiator, the plug is mounted in front of the radiator through screws, and used as a front cover.

The level gauge is provided at a upper portion of the base, the base and the driving power supply contact with the position of the connection.

The light source is attached on the horizontal end face of the radiator through a graphene-containing heat-conducting silicone grease, and further fixed by, for example, screws, the lens is fixedly mounted on the horizontal end surface of the radiator by, for example, screws, the light source is provided between the radiator and the lens. A graphene-containing heat-conducting silicone grease is provided between the light source and the radiator for achieving heat conduction and reducing thermal resistance. The graphene-containing heat-conducting silicone grease material employed has been disclosed in applicants' prior patent CN201210119361.9, not described in detail herein.

The radiator preferably employs an aluminum material or any commercially available aluminum alloy material, in addition, may also be selected from a ceramic material or an iron material, which is the main medium for the heat conduction of the radiator.

The radiator is a semicircular column, the semicircular surface is shaped into a hollow grille, which increases its contact area with the air, to further optimize the heat conduction. Since in the heat dissipation process, heat transfer of the LED lamp is mainly relied on convection between the radiator and the air. Excluding the influence of external winds, it is mainly relied on natural convection. Natural convection is caused by that: the cold air contacted with the radiator is raised after naturally heated by the radiator, and the surrounding cold air continues to be replenished, which continuously circulates to take the heat away. By providing a shape of hollow grille, increasing the contact area with the air, it can take away the heat on the radiator to the utmost extent.

However, the size of the radiator will also affect the heat dissipation effect. If the size of the radiator is too large, then the hot air in its middle portion raises, there is no enough ambient cold air to be replenished. In this case, as a result, the heat dissipation efficiency of the middle portion is lowered, the temperature rises, and the “heat island effect” is formed, the lifetime of the light source will decrease. With this in mind, the design of the size of the radiator cannot produce heat island effect, while maximizing heat dissipation efficiency. According to our research, when the shape of the radiator is constant, in terms of horizontal rectangular longitudinal section of the radiator, the length of the rectangular longitudinal section is 100˜300 mm, preferably 150˜250 mm, and further preferably 180˜220 mm, for example, may be 190 mm, 195 mm, 200 mm, 205 mm, 210 mm, etc., the width of the rectangular longitudinal section is 20 mm˜80 mm, preferably 30˜70 mm, further preferably 40˜60 mm, may be 45 mm, 46 mm, 47 mm, 48 mm, 49 mm, 50 mm, 51 mm, 52 mm, 53 mm, 54 mm, 55 mm, etc. The radiator is a semicircular column, the semicircular radius of its cross section is generally 10˜40 mm, preferably 15˜35 mm, more preferably 20˜30 mm, may be 21 mm, 22 mm, 23 mm, 24 mm, 25 mm, 26 mm, 27 mm, 28 mm, 29 mm, 30 mm, etc. Usually, if the size is controlled in the above range, the heat dissipation effect is relatively good. Through a lot of attempts, the use of this size is also convenient for post-mounting operations, and more convenient to place in the sodium lamp casing.

Under the premise of shape and size optimized, in order to further increase the heat conduction and heat radiation rate under the premise of shape and size optimization, in the present invention, a grapheme-containing fluororesin composite is combined with a radiator. The grapheme-containing fluororesin heat dissipating material is sprayed on the semicircular outer surface of the radiator to enhance heat dissipation efficiency of the radiator. The grapheme-containing fluororesin composite employed (may also be referred to as RLCP grapheme fluororesin composite) has disclosed in applicants' prior patent CN201310089504.0, not described in detail herein.

The power supply component employs a high-efficiency, high power factor, constant current isolated driving power supply, a whole consisting of a plurality of electronic elements. The power supply employs cylindrical integrated design, it is artistic, while the cylinder is a hollow cylinder with a height of 5-6 cm. To ensure good heat dissipation of the driving power supply while not exposing the electronic elements to the outside, which improves the safety factor. The heat generated during the operation of the driving power supply is transmitted to the fixed radiator by heat conduction, and then radiated in the form of radiation and convection to prevent damage to the core electrical elements of the power supply and improve the service life of the driving power supply.

The LED light source component may employs various types of light sources, preferably COB light source which is an integrated lamp beads. Compared to common LED lamp beads, the COB integrated light source has higher light efficiency and a smaller color tolerance. And a chip of the COB light source is preferably a flip-chip technique COB light source, a flip-chip technique eliminates the sapphire substrate, reduces thermal resistance, and further enhances the heat dissipation of the LED lamp.

The COB light source lamp beads provided by the present invention is distributed in a straight line on the substrate, after a lot of screening, and considering the problem of heat, the material selected for the substrate is superconducting aluminum, which achieves the best effect in terms of heat conduction efficiency, to further reduces the light decay, and extends the service life.

The material of the lens provided by the present invention may be glass, PC or PMMA, preferably glass.

At present, most of the LED lights emit light in a Langer-type distribution with a strong central intensity and a symmetrical circular spot distribution that cannot be directly used for road illumination. The present invention optimizes the lens, directly distributes light on the secondary optical lens. The distributed light is in a batwing shape, uniform illumination, which prevents glare, and has a light extraction efficiency of more than 95%, and the carrier PCB substrate for fixing the LED can employ any shape that meets the design requirements, and the appearance can be diversified.

The fixed holder may be any heat conductivity, good structural material, preferably copper, iron, ceramics, aluminum and corresponding alloys, more preferably aluminum and its alloys, ceramics, and most preferably an aluminum alloy material. In the present invention, the fixed holder is made of aluminum alloy, strengthens effect of the heat conduction and heat radiation, the present invention integrally designs the holder into a semicircular shape which is highly attached to the cross section of the radiator and conforms to semicircular shape in the same shape as the shape of the cross section of the radiator. During the mounting operation, the illumination assembly structure is firmly fixed on the fixed support by screws, and then the fixed holder is connected to the base by screws. The radiator and the air transfer heat, while a part of the heat is transmitted to the fixed holder in the form of heat conduction, and the curved surface of the fixed holder is highly attached to the radiator, and the distance of the thinnest attachment is 0.3 cm. On the one hand, it plays a fixed role, while the fixed holder further transfers the heat generated during the operation of the light source, reduces the rate of occurrence of light decay, and extends the service life.

The base component to which the fixed holder and the driving power supply are connected may be made of any one of nylon, metal and PTFE. In the present invention, it is preferably PTFE, considering that the lamp is mounted in the surrounding environment in the form of exposure, it must react with the substances in the air to cause corrosion and aging phenomenon, etc. The use of PTFE material can minimize the occurrence of corrosion and aging. In addition, since the thermal resistance of PTFE is very large, it can better avoid mutual heat influence and thermal interference between the front end radiator and the driving power supply.

Taking into account the particularity of the mounting angle of the lamp, and influence from horizontal moment, the overall structure of the base is designed as an intermediate settled column. According to the experiments, it is found that the stability of the intermediate structure of the base column is the best when the sinking distance is 5 cm to 6 cm. This structure serves to stabilize the connection, and the fixed holder does not affect the mounting operation.

If the support is a integrally formed structure, the support is made of aluminum alloy or other materials, preferably aluminum alloy.

The materials of the plug may be any one of nylon, metal and PTFE. In the present invention, it is also preferably an aluminum alloy, such that the overall appearance of the lamp more harmonious and artistic, it also further accelerates the heat transfer to the radiator and plays a role in assisting heat dissipation. Considering the lamp is mounted around the environment in a closed form, after a long period of use, it will react chemically with substances in the air, and it will also cause corrosion and aging from the inside. Because the radiator employs integrated processing, there will be glitches at the top of the radiator, which brings some security risks to the mounting operator, while the degree of aesthetics will also decrease, in order to solve this problem, the plug is designed to tighten attached to the semicircle of the top of the radiator, and the plug weight is controlled in the range of 250 g to 300 g, to prevent a certain moment from affecting the lamp mounting stability.

The level gauge is any commercially available level bubble, the shape can be any shape of a cylinder or a square. Material is selected as plastic. The present invention optimizes the process of mounting operation, considering the special mounting angle of the whole lamp, the level gauge is combined with the base, and the level gauge is provided on the top of the base, where the base is in contact with the drive power supply, 6 cm-7 cm away from the lowest end of the driving power supply. Make the level gauge to achieve the best results. During the mounting operation, the mounting operator is given a horizontal reference value to measure whether the mounting is in place. The overall stability of the lamp is enhanced from the side, and the safety factor is increased.

The present invention further provides a road illumination lamp, comprising a lamp casing and a illumination assembly, the lamp casing may employ conventional sodium lamp casing.

The illumination lamp also has a holder and a reflector, the reflector is fixedly mounted by screws in the lamp casing, a circular opening is provided at the tail of the reflector for the illumination assembly to pass through.

The illumination assembly is externally connected on the holder, and the holder is fixed to the lamp casing by screws.

The embodiments of the present invention will be described in detail below with reference to the examples and the accompanying drawings, by which, the implementation process of how to apply the technical means to solve the technical problems and achieve the technical effect can be fully understood and implemented.

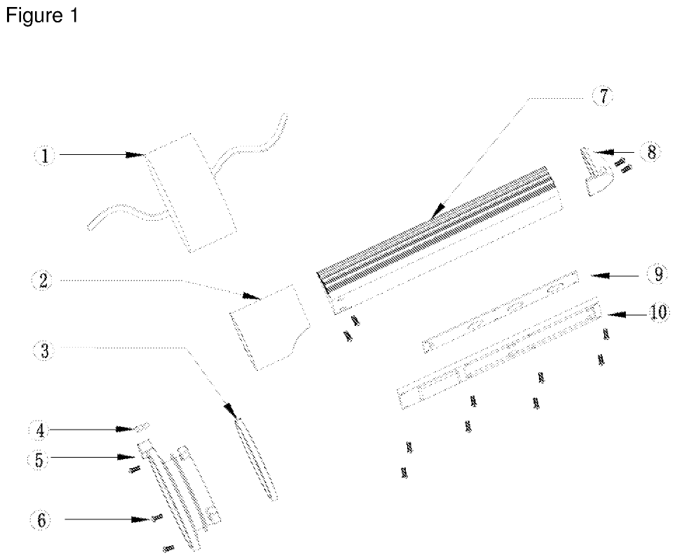

As shown in FIG. 1, the present invention provides a novel road illumination lamp illumination assembly, comprising: a drive power supply 1, the fixed support 2, a rubber ring 3, level gauge 4, the base 5, a radiator 7, a plug 8, an LED light source 9 and a lens 10. The driving power supply 1 is fixedly connected to the base 2 by screws 6, the base 5 is connected to the fixed support 2, the rubber ring 3 is provided at an intermediate position of the connection between the fixed support 2 and the base 5 for two sealed connections. In addition, although the structure in which the base 5 and the fixed support 2 are separated from each other is illustrated in FIG. 1, the two structures may be integrally molded and appear in the form of one member, which may also be referred to as support. The fixed support 2 is further connected to the radiator 7, the plug 8 is attached to the front of the radiator by screws 6 and used as a front cover. The level gauge is provided at the upper portion of the base 5 at a position where the base 5 is in contact with the driving power supply 1. The lens 10 is fixedly mounted by screws in a horizontal end face of the radiator, the light source 9 is provided between the radiator 7 and the lens 10, and attached on the horizontal end face of the radiator through a graphene-containing heat-conducting silicone grease, further fixed by screws. The entire surface of the semicircular outer surface of the radiator 7 is sprayed with a graphene-containing fluororesin composite.

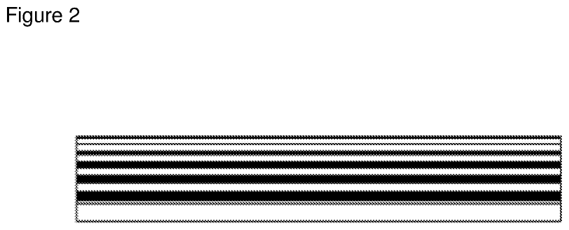

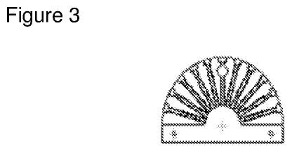

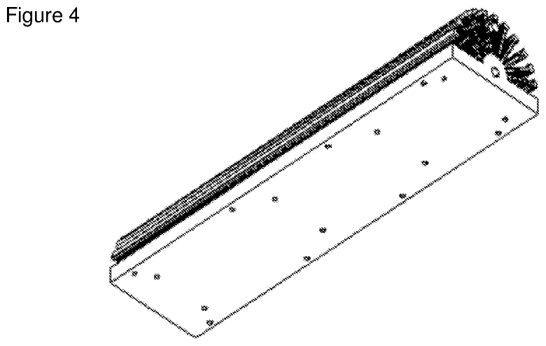

As shown in FIGS. 2 to 4, the radiator is a semicircular column, the semicircular surface of the radiator is shaped into a hollow grille, which increases the contact area with the air, to further optimize the heat conduction. The size of the horizontal rectangular longitudinal section of the radiator is controlled by a length (100˜300 mm)*width (20 mm˜80 mm), and the semicircular radius of the semicircular column cross section is controlled to be 10˜40 mm.

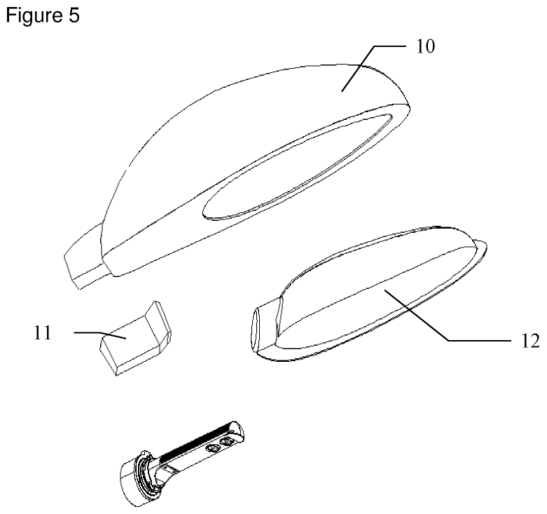

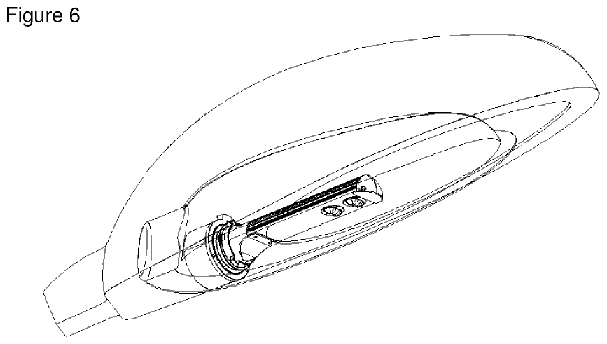

As shown in FIGS. 5 and 6, the road illumination lamp includes a lamp casing 10, an illumination assembly, the holder 11 and the reflector 12. The reflector 12 is fixedly mounted in the lamp casing 10 by screws, a circular opening is provided at the tail of the reflector for the illumination assembly to pass through. The illumination assembly is externally connected to the holder 11, and the holder 11 is fixed to the lamp casing by screws.

### Example

The materials used in the following examples are described as follows, and each of the materials used in the examples are commercially available materials.

The graphene-containing fluororesin composite used in the following examples is specifically:

50% by mass of fluorosilicone resin (Shanghai Huiyan New Materials Co., Ltd.), 40% by mass of acrylic acid diluent, 4% by mass of polypropylene, an electron transfer-type organic compound, 1% by mass of graphene, 1% by mass of carbon nanotubes, 1% by mass of titanium pigment, 3% by mass of curing agent epoxy resin are mixed according to the steps and stirred at room temperature of 800-1000 rpm to form the target coating.

The graphene-containing heat-conducting silicone grease used in the following examples is specifically:

The composition of additives used and their mass ratio are as follows: The mass ratio of carbon nanotubes, graphene and particulate matter is 1:6:3, and the volume ratio of the overall additive to the silicone oil is 6:4.

The carbon nanotubes have a purity of ≥95 wt % and an ash content of ≤0.2 wt %.

The particulate matter is a paraffin-coated phase change capsule, and the material including the paraffin wax is alumina having a phase transition temperature of 29° C. and an average particle diameter of 60 μm.

The silicone oil is selected from a mixture of dimethicone and hydrogen-containing silicone oil having a viscosity of 500,000 cSt at 25° C.

### The Method of Preparation

The graphene and the particulate matter having a mass ratio of 6:3 are poured into a small amount of silicone oil for premixing, and under the condition of mechanical stirring, the carbon nanotubes of the desired quality are slowly added, and the silicone oil is replenished at any time until the desired silicone oil content. After continuing mechanical stirring for half an hour, the mixture was further milled for one hour using a counter roll mill to obtain the final silicone grease.

### Example 1

According to FIGS. 2 to 4, a radiator is fabricated. The horizontal rectangular longitudinal section of the radiator made of aluminum alloy (AL6063-T5) has a length of 200 mm and a width of 50 mm, and a semicircular radius of the cross section is 31 mm.

The light source used is the COB light source of Shenzhen Avenue Semiconductor Co., Ltd., model G4N2CD120-F1221-L1350336h, and the power supply is DC output power supply of Shenzhen Fushuo Optoelectronics Technology Co., Ltd., model FS-30W-0.9A.

According to the method described in FIG. 1, an aluminum support (The size is φ88 mm*74.5 mm) was made of AL6063. By using the PC level gauge, the PMMA lens, and the PC plug, the above members were assembled in the manner of FIG. 1 to obtain the module of Example 1.

Wherein, Thermalright Silicone from Taiwan is coated between the bottom plane of the radiator and the LED light source.

### Example 2

A radiator was fabricated according to FIGS. 2 to 4 in the same manner as in Example 1, and the radiator was made of aluminum alloy (AL6063-T5). The horizontal rectangular longitudinal section of the radiator has a length of 200 mm and a width of 50 mm. The semicircular radius of the cross section is 31 mm.

The surface of the radiator is degreased, decontaminated and cleaned, the target coating is thoroughly stirred and poured into the spray gun. The pressure of the spray gun is set to 0.4 MPa, aiming at the target surface, the distance between the two is 10-20 cm, and is sprayed back and forth 2-3 times, so that the coating evenly covers the surface of the object. The coating is uniform and glossy, and its thickness can be optimized according to needs, the coating may dry naturally to cure for 12 hours, or bake in an oven for 10 minutes to cure quickly.

A module was fabricated in the same manner as in Example 1, except that, the above-mentioned graphene-containing heat-conducting silicone grease is coated between the bottom surface of the radiator and the LED light source.

### The Method of Detection:

High precision multi-channel temperature tester AT4532 is employed: multi-channel temperature tester is a meter suitable for multi-point temperature simultaneous real-time monitoring and tracking. It has the advantages of convenient measurement, high precision and reusable thermocouple test points. Equipped with software, the entire temperature rise process can be recorded in a curved way, which is convenient for saving analysis and communication. It is used for the detection of multi-point temperature fields by manufacturers and quality inspection departments in home appliances, motors, electric appliances, thermostats, transformers, ovens, thermal protectors, etc., and ideal tool for temperature rise testing of daily electrical appliances such as power tools and illumination lamps.

Test conditions: ambient temperature: 25° C., ambient humidity: 55%.

Hot-wire method: Method for determining thermal conductivity of non-metallic solid materials GB10297-88. Multi-channel temperature tester thermocouples are connected to the light source substrate and the radiator fins, the sample was illuminated for 120 minutes, and recording the current temperature every 10 minutes is setted. Compare to temperature difference between Example 1 and Example 2, the resulting data are shown in Table 1.

TABLE 1
Effect of graphene heat conductive grease and graphene
coating heat dissipation on temperature rise

| | Light source substrate temperature/° C. | | | Radiator fin temperature/° C. | | |
|---|---|---|---|---|---|---|
| Time | | | Temperature | | | Temperature |
| difference/min | Example 2 | Example 1 | difference/° C. | Example 2 | Example 1 | difference/° C. |
| 0 | 25 | 25 | 0 | 25 | 25 | 0 |
| 10 | 32.3 | 48.5 | 16.2 | 27.8 | 41.6 | 13.8 |
| 20 | 44.2 | 60.7 | 16.5 | 39.6 | 53.3 | 13.7 |
| 30 | 52.3 | 68 | 15.7 | 47.3 | 61 | 13.7 |
| 40 | 58.7 | 73.2 | 14.5 | 53.2 | 65.4 | 12.2 |
| 50 | 62.5 | 75.6 | 13.1 | 57.3 | 68.7 | 11.4 |
| 60 | 64.8 | 77.5 | 12.7 | 59.6 | 71.2 | 11.6 |
| 70 | 65.4 | 78.3 | 12.9 | 60.5 | 71.6 | 11.1 |
| 80 | 66.6 | 79.2 | 12.6 | 61.2 | 72.8 | 11.6 |
| 90 | 67.2 | 80.5 | 13.3 | 62.3 | 73.5 | 11.2 |
| 100 | 67.8 | 80.9 | 13.1 | 63.1 | 74.6 | 11.5 |
| 110 | 68.4 | 81.5 | 13.1 | 64.2 | 75.5 | 11.3 |
| 120 | 69.1 | 82.3 | 13.2 | 65.3 | 76.5 | 11.2 |

For Example 1, it can be seen, by providing the radiator as a semicircular column, the road illumination assembly obtained from the Example 1 realizes an integrated structural design, which reduces the mounting volume of the lamp assembly. The lamp of Example 1 is equipped with an universal connecting component for a conventional sodium lamp or an LED lamp to achieve close connection with the structure of a light source assembly inside the conventional road lamp.

In Example 2, two graphene materials are further incorporated. It can be seen from Table 1 that the temperature rise of the light source substrate of Example 2 using the graphene material is significantly slower than that of the sample of Example 1 without using the graphene material, and the temperature difference at the final steady state is 13° C., indicating the system has strong heat dissipation after using graphene material; it can be seen from the temperature difference between the light source substrate and the radiator fin that the temperature difference after spraying the graphene material is about 3° C., and the temperature difference reaches about 6° C. without spraying graphene material. It can be seen that the system has better heat radiation capability and lowers LED chip temperature after using the graphene material. It can be seen that the present invention further improves the light efficiency of the light source by further adding the RLCP fluororesin composite coating and the graphene heat-conducting silicone grease material, reduces the light decay, and improves the heat dissipation efficiency of the radiator.

In summary, the present invention provides a light source assembly, a illumination assembly and a road illumination lamp, the radiator used is set to a semicircular column in the light source assembly, the illumination assembly and the road illumination lamp of the present invention. The lamp of the present invention is equipped with universal connecting component for a conventional sodium lamp or an LED lamp to achieve close connection with the structure of a light source assembly inside the conventional road lamp. By integrating a plurality of high-power LED beads to a substrate, providing an integrated lens with specific light distribution, matching the structural design of the radiator, and applying heat conduction, heat storage and heat dissipation materials, the lamp of the present invention overcomes the defects of conventional road lamps and common LED road lamps, and achieves advantages of low light decay, high light efficiency, high energy saving rate, long service life, quick non-destructive replacement, and the like.

All of the above-mentioned first implementations this intellectual property, and there are no restrictions on other forms of implementing this novel product and/or new method. Those skilled in the art will utilize this important information and modify the above to achieve a similar implementation. However, all modifications or changes are based on that the novel products of the present invention are reserved.

The above description is only a preferred examples of the present invention, and is not intended to limit the present invention in other forms. Any person skilled in the art may use the technical content disclosed above to change or modify to the equivalent examples. However, any simple modifications, equivalent variations and changes made to the above examples in accordance with the technical spirit of the present invention Without departing from the technical solution content of the present invention are still within the scope of protection of the technical solutions of the present invention.

1. A light source assembly, comprising: a radiator and an LED light source; the radiator is a radiator of semicircular column.

2. The light source assembly according to claim 1, wherein the LED light source is attached on the horizontal end face of the radiator through a graphene-containing heat-conducting silicone grease.

3. The light source assembly according to claim 1, wherein the semicircular entire outer surface of the semicircular column of the radiator is sprayed with a graphene-containing fluororesin material.

4. The light source assembly according to claim 1, wherein the semicircular surface of the radiator is shaped into a hollow grille.

5. The light source assembly according to claim 1, wherein the radiator employs an aluminum material, a ceramic material, and/or other metal material having good heat dissipation performance.

6. An illumination assembly, comprising: a light source assembly including a radiator and an LED light source, a driving power supply, a support, a level gauge, a plug, and a lens.

7. The illumination assembly according to claim 6, wherein the LED light source employs a COB light source.

8. The illumination assembly according to claim 6, wherein the driving power supply is connected to the support, the support is connected to the radiator, the LED light source is attached and fixed on the horizontal end face of the radiator through a graphene-containing heat-conducting silicone grease, the lens is fixedly mounted on the horizontal end face of the radiator, the LED light source is provided between the radiator and the lens.

9. The illumination assembly according to claim 6, wherein the radiator is a radiator of semicircular column.

10. A road illumination lamp, comprising: a lamp casing and the illumination assembly of claim 6, and the lamp casing employs the conventional sodium lamp casing.

11. The road illumination lamp according to claim 10, further comprising: a holder and a reflector, the reflector is fixedly mounted in the lamp casing, a circular opening is provided at the tail of the reflector for the illumination assembly to pass through.

12. The light source assembly according to claim 2, wherein the semicircular entire outer surface of the semicircular column of the radiator is sprayed with a graphene-containing fluororesin material.

13. The light source assembly according to claim 2, wherein the semicircular surface of the radiator is shaped into a hollow grille.

14. The light source assembly according to claim 3, wherein the semicircular surface of the radiator is shaped into a hollow grille.

15. The light source assembly according to claim 12, wherein the semicircular surface of the radiator is shaped into a hollow grille.

16. The light source assembly according to claim 2, wherein the radiator employs an aluminum material, a ceramic material, and/or other metal material having good heat dissipation performance.

17. The light source assembly according to claim 3, wherein the radiator employs an aluminum material, a ceramic material, and/or other metal material having good heat dissipation performance.

18. The light source assembly according to claim 4, wherein the radiator employs an aluminum material, a ceramic material, and/or other metal material having good heat dissipation performance.

19. The light source assembly according to claim 12, wherein the radiator employs an aluminum material, a ceramic material, and/or other metal material having good heat dissipation performance.

20. The light source assembly according to claim 13, wherein the radiator employs an aluminum material, a ceramic material, and/or other metal material having good heat dissipation performance.
